(19) United States
(12) Patent Application Publication
(10) Pub. No.: US 2007/0299958 A1
(43) Pub. Date: Dec. 27, 2007

(54) STATE SYNCHRONIZATION APPARATUSES AND METHODS

(75) Inventor: Chih-Lin Hu, Tainan City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/767,395

(22) Filed: Jun. 22, 2007

(30) Foreign Application Priority Data
Jun. 23, 2006 (TW) TW95122646

(51) Int. Cl. G06F 15/173

(52) U.S. Cl. 709/223

(57) ABSTRACT

A method for state synchronization, performed by a first electronic apparatus, comprises the following steps. A first service state version identification (ID) is acquired from a local cache of the first electronic apparatus. Multiple second service state version IDs stored in local caches of second electronic apparatuses are acquired by querying the second electronic apparatuses. It is determined whether each second service state version ID is older than the first service state version ID. A forward update request is transmitted to at least one second electronic apparatus owning the older second service state version ID, enabling the second electronic apparatus owning the older second service state version ID to activate an upward check procedure to update the older second service state version ID.

### BACKGROUND

The invention relates to state synchronization, and more particularly, to state synchronization apparatuses and methods for very large-scale distributed network environments.

Devices in distributed environments may share common states for service coordination and collaboration, particularly in event-driven service management systems. Typically, in service management systems, service state change notifications may be processed asynchronously: a service (or an administration console) sequentially notifies all devices of all changed common states. The values of the common state are stored (or cached) in the devices. The devices, however, maintain cached common states in different ways, and thus, may have inconsistent common state values, thereby causing failure of service coordination.

### SUMMARY

Methods for state synchronization, performed by a first electronic apparatus, are provided. An embodiment of a method for state synchronization, performed by a first electronic apparatus, comprises the following steps. A first service state version identification (ID) is acquired from a local cache of the first electronic apparatus. Multiple second service state version IDs stored in local caches of second electronic apparatuses are acquired by querying the second electronic apparatuses. It is determined whether each second service state version ID is older than the first service state version ID. A forward update request is transmitted to at least one second electronic apparatus owning the older second service state version ID, enabling the second electronic apparatus owning the older second service state version ID to activate an upward check procedure to update the older second service state version ID. The first and second service state version IDs are generated by a service resident on a third electronic apparatus. The first, second and third electronic apparatuses are organized in an event casting tree, the third electronic apparatus is a root node of the event casting tree, and the first and second electronic apparatuses are leaf nodes of the event casting tree.

An embodiment of a method for state synchronization, performed by a first electronic apparatus, comprises the following steps. An upward check request is received from a second electronic apparatus, the upward check request comprises a first service state version ID and a first service state value corresponding to the first service state version ID. A second service state version ID stored in a local cache of the first electronic apparatus is acquired. The upward check request is transmitted to a third electronic apparatus to activate an upward check procedure when the second service state version ID is older than the first service state version ID. The upward check procedure transmits the upward check request to an electronic device causing inconsistency between the first and second service state version IDs. It is determined whether the third electronic apparatus is available. If the third electronic apparatus is unavailable the second service state version ID and the second service state value stored in the local cache of the first electronic apparatus are replaced with the first service state version ID and the first service state value. A downward update request is transmitted to the second electronic apparatus to activate a downward update procedure downwardly notifying all nodes directly or indirectly connecting to the first electronic apparatus of information instructing a notified node to store the first service state value corresponding to the first service state version ID. The first, second and third electronic apparatuses are organized in an event casting tree, the first electronic apparatus is a parent node of the second electronic apparatus, and the third electronic apparatus is a parent node of the first electronic apparatus.

An embodiment of a method for state synchronization, performed by a first electronic apparatus comprising a local cache storing a first service state version ID and a first service state value corresponding to the first service state version ID, comprises the following steps. A forward update request comprising a second service state version ID and a second service state value corresponding to the second service state version ID is received from a second electronic apparatus, the second service state version ID being newer than the first service state version ID. A downward update request comprising a third service state version ID and a third service state value corresponding to the third service state version ID is received from a third electronic apparatus after receiving the forward update request. The first service state version ID and the first service state value in the local cache of the first electronic apparatus are respectively replaced with the third service state version ID and the third service state value. It is determined whether the third service state version ID is newer than the second service state version ID. A backward update request is transmitted to the second electronic apparatus in order to activate a master node transition procedure when the third service state version ID is newer than the second service state version ID. The master node transition procedure transfers tasks for transmitting forward update requests from the second electronic apparatus to the first electronic apparatus. The first, second and third electronic apparatuses are organized in an event casting tree, the first and second electronic apparatuses are leaf nodes of the event casting tree, and the third electronic apparatus is a parent node of the first electronic apparatus.

Systems for state synchronization are provided. An embodiment of a system for state synchronization comprises a first, a second, a third and a fourth electronic apparatuses. The first electronic apparatus comprises a service. The first, second, third and fourth electronic apparatuses are organized in an event casting tree. The first electronic apparatus represents a root node of the event casting tree, the second electronic apparatus represents a relay node of the event casting tree, and the third and fourth electronic apparatuses represent leaf nodes of the event casting tree. The third and fourth electronic apparatuses subscribe multiple event notifications to the service. The first electronic apparatus transmits the event notifications hierarchically and sequentially to the third and fourth electronic apparatuses via the second electronic apparatus. The fourth electronic apparatus acquires a first service state version ID from a local cache thereof, acquires a second service state version ID stored in a local cache of the third electronic apparatuses by querying the third electronic apparatus, determines whether the second service state version ID is older than the first service state version ID, and transmits a forward update request to the third electronic apparatus when the second service state version ID is older than the first service state version ID, enabling the third electronic apparatus to activate an upward check procedure to update the older second service state version ID.

### BRIEF DESCRIPTION OF DRAWINGS

The invention will become more fully understood by referring to the following detailed description with reference to the accompanying drawings, wherein:

FIG. 1 is a diagram of network architecture of an embodiment of a state synchronization system;

FIG. 2 is a diagram of a hardware environment applicable to an embodiment of a personal computer;

FIG. 3 is a diagram of an embodiment of a distributed event dissemination mechanism;

FIG. 4 is a diagram of state inconsistency among leaf nodes;

FIG. 5 is an exemplary event casting tree;

FIG. 6 is a flowchart of an embodiment of a state synchronization method executed by a master node;

FIG. 7 is a flowchart of an embodiment of a state synchronization method executed by a leaf node other than a master node;

FIG. 8 is a flowchart of an embodiment of a state synchronization method executed by a relay node or the root node;

FIG. 9a is a flowchart of an embodiment of a state synchronization method executed by a relay node;

FIG. 9b is a flowchart of an embodiment of a state synchronization method executed by a leaf node other than a master node;

FIG. 10 is a diagram illustrating exemplary forward updates;

FIGS. 11, 12 and 13 are diagrams of exemplary state synchronization;

FIG. 14 is a flowchart of an embodiment of a state synchronization method executed by a master node;

FIG. 15 is a diagram of an exemplary master node transition;

FIG. 16 is a diagram of a storage medium storing a computer program for carrying out state synchronization.

### DETAILED DESCRIPTION

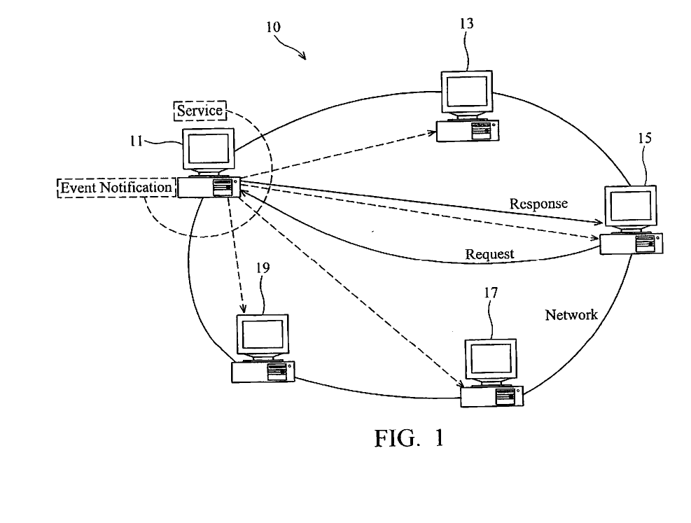

FIG. 1 is a diagram of network architecture of an embodiment of a state synchronization system 10, comprising personal computers 11, 13, 15, 17 and 19. The personal computers 11, 13, 15, 17 and 19 operate in a wired or wireless network or a combination thereof for connection therebetween. Those skilled in the art will recognize that the personal computers 11, 13, 15, 17 and 19 may be connected in different types of networking environments, and may communicate therebetween through various types of transmission devices such as routers, gateways, access points, base station systems or others. The state synchronization system 10 employs a publisher-subscriber (or push) model to notify connected computers of state changes. Specifically, the personal computer 11 advertises services thereof in a network, enabling personal computers 13, 15, 17 and 19 to discover and subscribe to the advertised services. The personal computer 11 operates as a state source for transmitting event notifications respectively comprising service state values to personal computers 13, 15, 17 and 19 in an asynchronous manner. The personal computers 13, 15, 17 and 19 may subscribe to the published service resident on the personal computer 11 (i.e. the publisher) prior to receiving subsequent event notifications indicating state changes of the subscribed service. When multiple personal computers subscribe to the same service, the personal computer 11 may transmit event notifications to the subscribing personal computers by unicasting, multicasting or broadcasting, and subsequently, the subscribing personal computers store service state values in their local caches. In addition, the subscribing personal computers can request service state values and replace cached service state values with service state values in a corresponding response. Note that personal computer 11 further transmits a valid duration indicating the duration of each corresponding service state value.

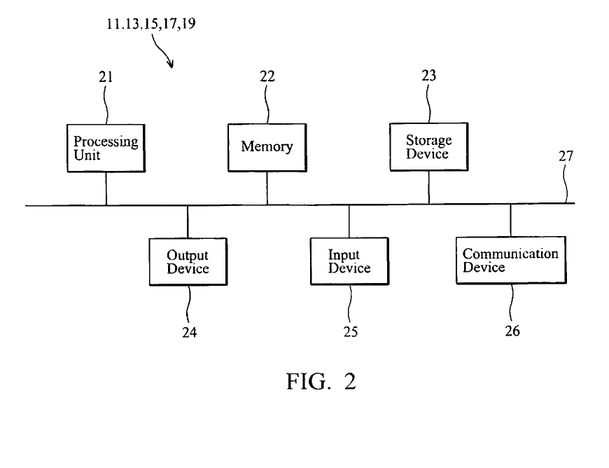

FIG. 2 is a diagram of a hardware environment applicable to an embodiment of personal computer 11, 13, 15, 17 or 19, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 21, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform state synchronization functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. The programmable consumer electronics may be mobile stations, projectors, displays, mp3 players, personal digital assistants (PDAs), digital video recorders or similar. Some embodiments may also be practiced in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

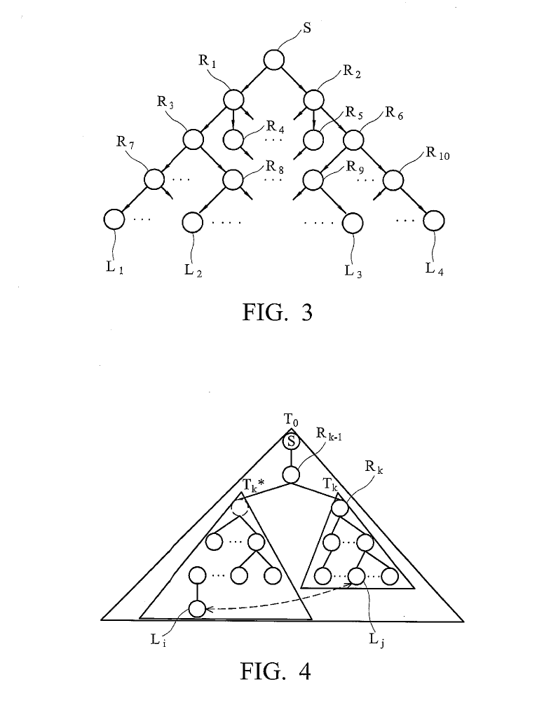

A distributed event dissemination mechanism is employed for efficiently transmitting event notifications to personal computers and electronic devices when the subscribing personal computers and electronic devices are part of a very large-scale distributed network environment. FIG. 3 is a diagram of an embodiment of a distributed event dissemination mechanism. All personal computers and electronic devices are organized into an event casting tree. Event notifications are delivered in a cascading manner from the top. An event casting tree consists of three types of nodes: a unique root node (e.g. S of FIG. 3); relay nodes (e.g. R₁ to R₁₀); and leaf nodes (e.g. L₁ to L₄). The root node S represents a personal computer or electronic device containing a service which is the event sender for transmitting event notifications to leaf nodes via numerous relay nodes. The leaf nodes L₁ to L₄ and others are event receivers for subscribing to the event notification service of the event sender. The relay nodes R₁ to R₁₀ and others are in-between nodes among the root node S and leaf nodes L₁ to L₄ and others. The relay nodes may be personal computers, electronic devices or network devices such as wireless access points, base stations, hubs, bridges, routers, gateways or similar.

An event notification may be organized by the following format:

Event notification

service_identifier sid;
service_location_reference slr;
relay_node_identifier rid;
state sValue;
versionvValue;
time tValue;
duration dValue;

An event notification includes several data fields such as a service identifier (sid), a service location reference (slr), a relay node identifier (rid), a service state value (sValue), a version identifier (dValue), a time at which the event notification is generated (tValue) and a valid duration (dValue). The version identifier (ID) differentiates an individual event (i.e. service state value) from multiple events. The version ID may be represented in a form of a service ID hyphenated by an event ID, organized in the following format:

version ID:=“service ID”−“event ID”.

The relay node identifier initiated as “null” is encapsulated in the first event notification sent by the root node to its child relay nodes. When receiving an event notification, a relay node appends its identifier to the relay node identifier of the received event notification and transmits the revised event notification to its child relay nodes or leaf nodes. In addition, the relay node records a tuple of parent node identifier and sid, vValue and sValue of the received event notification in a local database, denoted as <sid, parent's rid, vValue, sValue>. When receiving an event notification, a leaf node records a tuple of sid, slr, parent node rid (or the root node), vValue and sValue of the received event notification, denoted as <sid, slr, parent's rid, vValue, sValue>.

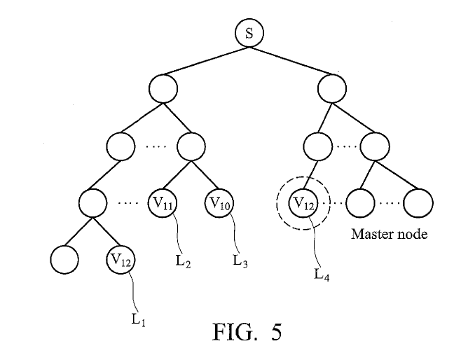

Two leaf nodes may have different versions of service state values corresponding to an identical service in course of service coordination. Inconsistent states among leaf nodes can be induced by many causes. For example, a broken relay node may temporarily interrupt event notification transfer or a data transmission jam may occur between two nodes, such as two relay nodes, a root node and a relay node, or a relay node and a leaf node. FIG. 4 is a diagram of state inconsistency among leaf nodes. An event casting tree T₀ has a root node S and relay nodes Rₖ₋₁, Rₖ* and Rₖ, the root node connects to the relay node Rₖ₋₁ as its child node, and the relay node Rₖ₋₁ connects to two relay nodes Rₖ* and Rₖ as its child nodes. When the relay node Rₖ* experiences an exceptional error, event notification can not be downwardly transmitted to all relay nodes and leaf nodes via the relay node Rₖ*, resulting in state inconsistency between sub-trees Tₖ* and Tₖ. When leaf nodes Lᵢ and Lⱼ inspect cached version IDs of service state values for service coordination and collaboration, it is detected that the version ID owned by the leaf node Lᵢ is older than that owned by the leaf node Lⱼ.

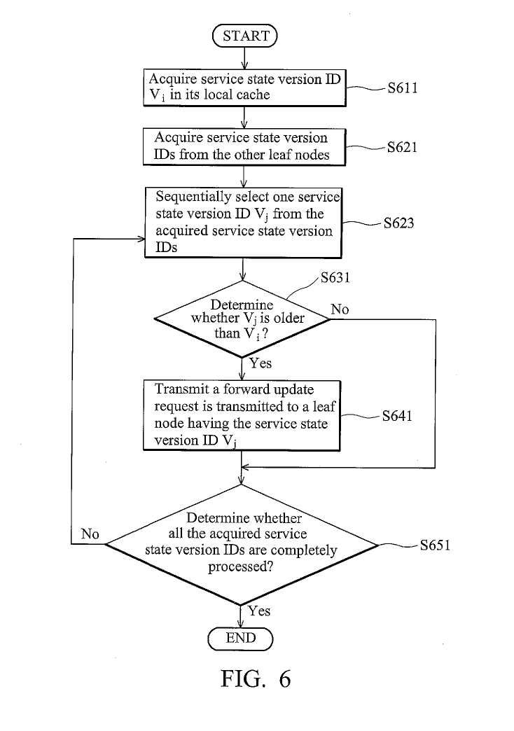

Let a collaborative group comprise m leaf nodes L₁, L₂ to Lₘ. All leaf nodes in the collaborative group store service state values corresponding to the same service in their local caches. All leaf nodes in the same collaborative group ideally have the same service state version ID of the cached service state values, i.e., vᵢ=vⱼ for any two leaf nodes Li and Lj in the same collaborative group. Prior to service coordination, leaf nodes L₁, L₂ to Lₘ compare their versions of the specific service state. To facilitate synchronizing states among leaf nodes, one node in the collaborative group serves as a master node. The master node collects service state version IDs from the other leaf nodes and then forwards newer service state values to those nodes with older states. Detailed descriptions for determining the master node are provided in the following. FIG. 5 is an exemplary event casting tree comprising four leaf nodes L₁, L₂, L₃ and L₄ respectively having service state values of service state version IDs V₁₂, V₁₁, V₁₀ and V₁₂, where a larger service state version ID number indicates a newer version than one with a smaller number. A leaf node having the largest service state version ID number located on the right or left the event casting tree, such as L₄, operates as a master node.

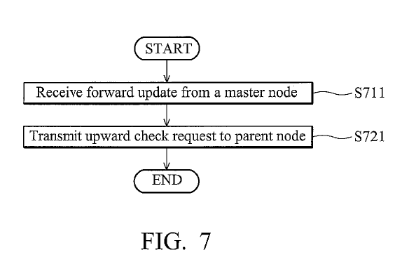

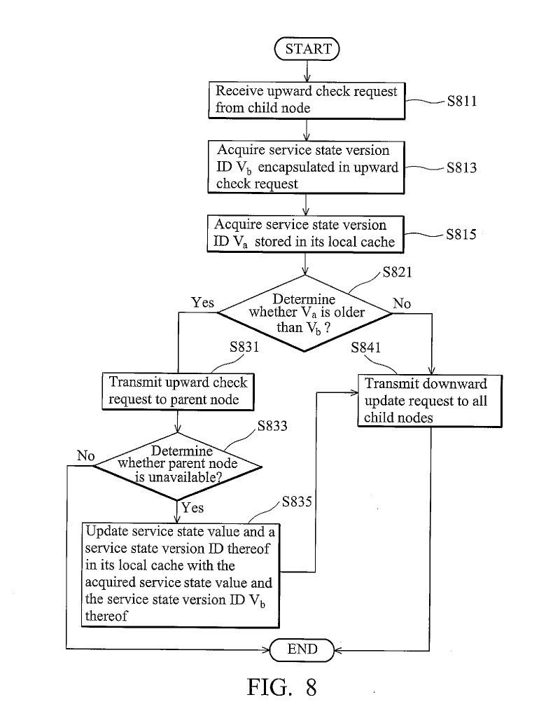

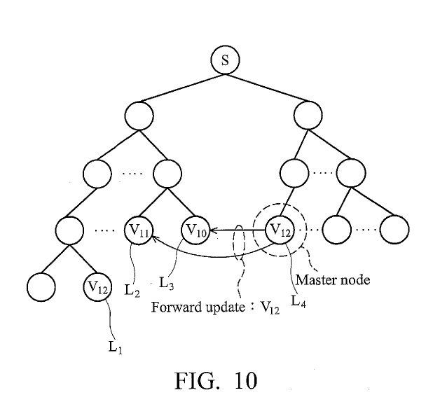

FIG. 6 is a flowchart of an embodiment of a state synchronization method executed by a master node such as L₄ of FIG. 5. In step S611, a service state version ID Vᵢ corresponding to the newest service state value is acquired from a local cache. The local cache may be implemented in the memory 22 or storage device 23 (FIG. 2). In step S621, service state version IDs are acquired from the other leaf nodes, such as L₁ to L₃ of FIG. 5, which respectively correspond to the newest service state value stored in local caches of the other leaf nodes by issuing requests to the other leaf nodes. In step S623, one service state version ID Vj is sequentially selected from the acquired service state version IDs, which correspond to one of the newest service state values stored in local caches of the other leaf nodes. In step S631, it is determined whether Vⱼ is older than Vᵢ. If so, the process proceeds to step S641, otherwise, to step S651. In step S641, a forward update request is transmitted to a leaf node having the service state version ID Vⱼ. The forward update request comprises the service state version ID Vᵢ and the corresponding service state value. The details of the subsequent operations in response to the received forward update request by a leaf node can refer to the description of FIG. 7 as follows. In step S651, it is determined whether all the acquired service state version IDs are completely processed. If so, the entire process ends, otherwise, the process proceeds to step S623. FIG. 10 is a diagram illustrating exemplary forward updates. Leaf node L₄ operating as a master node transmits forward update requests to leaf nodes L₂ and L₃ when executing a process as shown in FIG. 6.

FIG. 7 is a flowchart of an embodiment of a state synchronization method executed by a leaf node other than a master node, such as one of L₁ to L₃ of FIG. 5. In step S711, a forward update request is received from a master node. In step S721, an upward check request comprising a service state value and a service state version ID thereof acquired from the master node is transmitted to a parent node which may be a relay node or the root node. The parent node identifier may be acquired from its local cache.

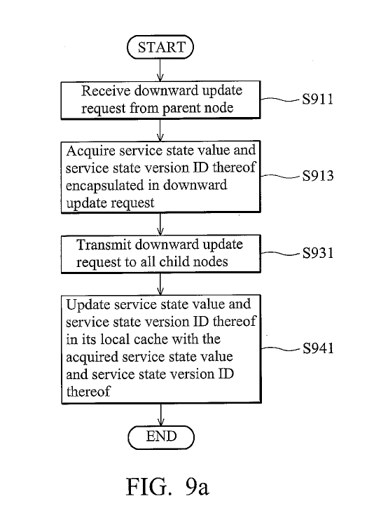

FIG. 8 is a flowchart of an embodiment of a state synchronization method executed by a relay node or the root node, such as one of S, R₁ to R₁₀ of FIG. 3. In step S811, an upward check request is received from a child node. In step S813, a service state version ID V_{b} encapsulated in the upward check request is acquired. In step S815, a service state version ID Vₐ stored in a local cache is acquired, where Vₐ corresponds to the current service state value stored in the local cache. In step S821, it is determined whether Vₐ is older than V_{b}. If so, the process proceeds to step S831, otherwise, to step S841. In step S831, an upward check request comprising a service state value and the service state version ID V_{b} thereof acquired from the previously received upward check request is transmitted to a parent node (may be a relay node or the root node). The parent node identifier may be acquired from its local cache. Ideally, when the parent node receives the upward check request, an upward check acknowledgement is sent in reply to indicate that the upward check request has been received. In step S833, it is determined whether the parent node is unavailable. If so, the process proceeds to step S835, otherwise, the entire process ends. For example, the parent node is unavailable when no upward check acknowledgement is received before the upward check request expires. In step S835, a service state value and a service state version ID thereof in its local cache are updated with the acquired service state value and the service state version ID V_{b}. In step S841, a downward update request comprising the service state value and the service state version ID Vₐ thereof acquired from its local cache is transmitted to all child nodes which may be relay nodes and/or leaf nodes. Note that the service state version ID Vₐ may be the same as or newer than the service state version ID V_{b} acquired from the received upward check request.

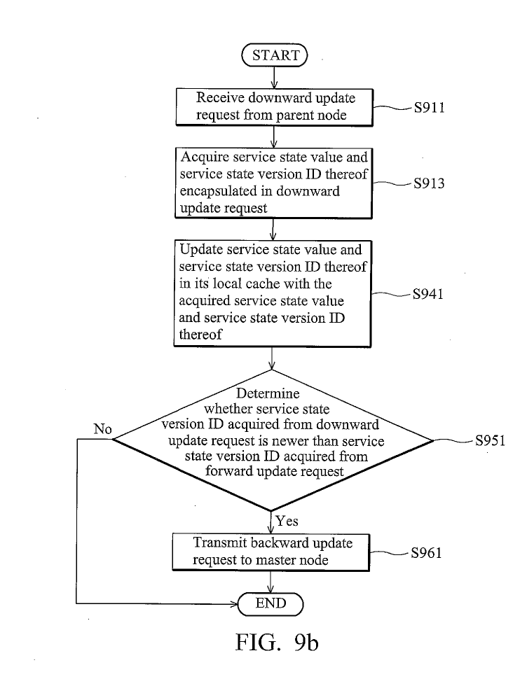

FIG. 9a is a flowchart of an embodiment of a state synchronization method executed by a relay node, such as one of R₁ to R₁₀ of FIG. 3. In step S911, a downward update request is received from a parent node. In step S913, a service state value and a service state version ID thereof encapsulated in the downward update request is acquired. In step S931, a downward update request comprising the service state value and the service state version ID thereof acquired from the previously received downward update request is transmitted to all child nodes which may be relay nodes and/or leaf nodes. In step S941, a service state value and a service state version ID thereof stored in its local cache are updated with the service state value and the service state version ID thereof acquired from the previously received downward update request.

FIG. 9b is a flowchart of an embodiment of a state synchronization method executed by a leaf node other than a master node, such as one of L₁ to L₃ of FIG. 3. The details of steps S911, S913 and S931 may follow the description of FIG. 9a. In step S951, it is determined whether the service state version ID acquired from the downward update request is newer than the service state version ID acquired from the forward update request. If so, the process proceeds to S961, otherwise, the entire process ends. In step S961, a backward update request is transmitted to a master node, such as L₄ of FIG. 5, in order to activate a master node transition procedure. The backward update request comprises a service state value and a service state version ID thereof acquired from the downward update request.

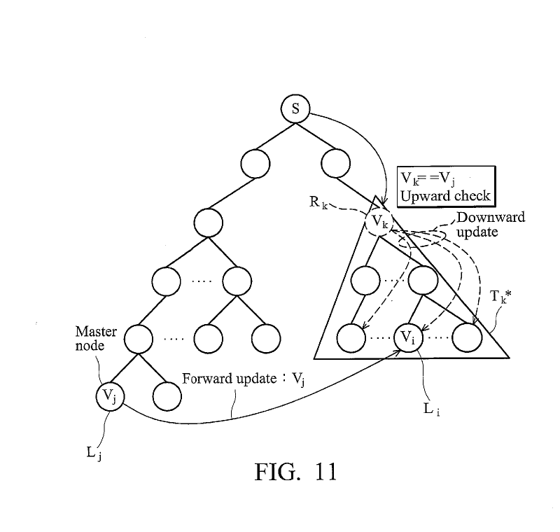

Detailed descriptions of state synchronization methods as shown in FIGS. 6 to 9a and 9b are provided in the following. FIG. 11 is a diagram of exemplary state synchronization. When a master node Lj detects that the owned service state version ID Vⱼ is newer than a service state version ID Vᵢ owned by a leaf node Lᵢ, a forward update request is transmitted to the leaf node Lᵢ (as shown in step S641 of FIG. 6). Referring to the method as shown in FIG. 7, when the leaf node Li receives the forward update request, a upward check request is transmitted to its parent node to activate a upward check procedure transmitting the upward check request to a node causing inconsistency among service state version IDs. Referring to the method as shown in FIG. 8, the upward check procedure sequentially transmits the upward check request to a relay node Rₖ. When the relay node Rₖ detects that the owned service state version ID is not older than a service state version ID acquired from the received upward check request, a downward update request is transmitted to all child nodes (as shown in step S841 of FIG. 8) in order to activate a downward update procedure. The downward update procedure downwardly updates service state values and service state version IDs thereof owned by all child nodes directly or indirectly connecting to the relay node Rₖ. Referring to the method as shown in FIGS. 9a and 9b, all nodes in a subtree Tₖ* update service state values and service state version IDs thereof in their local caches with a service state value and a service state version ID thereof in the received downward update request (as shown in step S941 of FIGS. 9a and 9b).

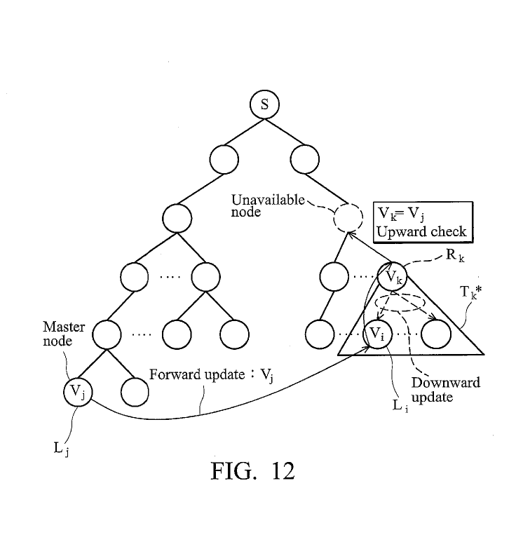

FIG. 12 is a diagram of exemplary state synchronization. When a master node Lⱼ detects that the owned service state version ID Vⱼ is newer than a service state version ID Vᵢ owned by a leaf node Lᵢ, a forward update request is transmitted to the leaf node Lᵢ (as shown in step S641 of FIG. 6). Referring to the method as shown in FIG. 7, when the leaf node Li receives the forward update request, a upward check request is transmitted to its parent node to activate an upward check procedure transmitting the upward check request to a node causing inconsistency among service state version IDs. Referring to the method as shown in FIG. 8, the upward check procedure sequentially transmits the upward check request to a relay node Rₖ. When the relay node Rₖ detects that its parent node is unavailable, a service state value and a service state version ID thereof stored in a local cache are updated with a service state value and a service state version ID Vⱼ thereof acquired from the received upward check request (as shown in step S835 of FIG. 8), and a downward update request is transmitted to all child nodes (as shown in step S841 of FIG. 8) in order to activate a downward update procedure. The downward update procedure downwardly updates service state values and service state version IDs thereof owned by all child nodes directly or indirectly connecting to the relay node Rₖ. Referring to the method as shown in FIGS. 9a and 9b, all nodes in a subtree Tₖ* update service state values and service state version IDs thereof in their local caches with a service state value and a service state version ID thereof in the received downward update request (as shown in step S941 of FIGS. 9a and 9b).

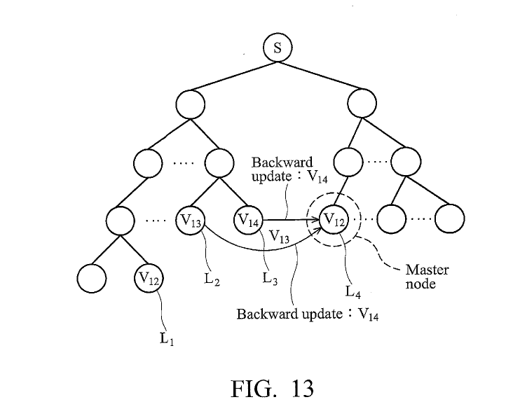

FIG. 13 is a diagram of exemplary state synchronization. After leaf nodes L₂ and L₃ receive forward update requests from a master node L₄, and the relevant nodes completely perform the required methods as shown in FIGS. 7, 8, 9a and 9b, the leaf nodes L₂ and L₃ respectively acquire service state version IDs V₁₃ and V₁₄ from the received downward update requests, wherein the service state version IDs V₁₃ and V₁₄ are newer than a service state version ID V₁₂ acquired from the received forward update request. Thus, the leaf nodes L₂ and L₃ respectively transmit backward update requests respectively comprising service state version IDs V₁₃ and V₁₄ to the master node L₄ in order to activate a master node transition procedure.

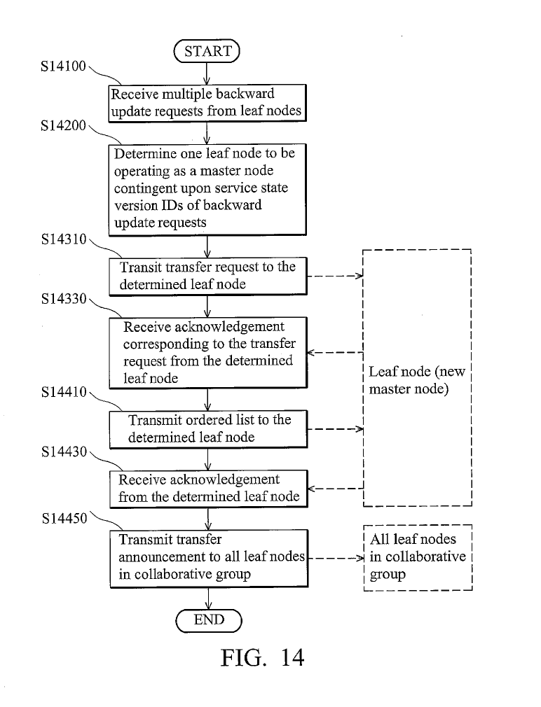

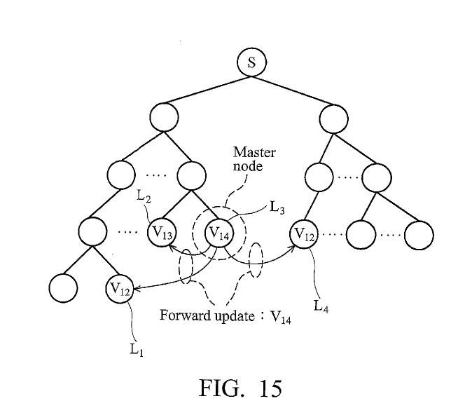

FIG. 14 is a flowchart of an embodiment of a state synchronization method executed by a master node, such as L₄ of FIG. 5. In step S14100, multiple backward update requests are received from leaf nodes, each backward update request comprises a leaf node identifier and a service state version ID. In step S14200, a leaf node to be operating as a master node is determined contingent upon service state version IDs of the backward update requests. Typically, a leaf node owning the largest service state version ID can be assigned to be a master node. In order to improve the determination efficiency, a principle is introduced to determine a master node. The principle may define a master node as the leaf node owning the largest service state version ID located on the right or left of an event casting tree, such as a leaf node L₃ of FIG. 13. In step S14310, a transfer request is transmitted to the determined leaf node, where the transfer request comprises information indicating that tasks of a master node (such as transmitting forward update requests) are to be transited to the determined leaf node. In step S 14330, an acknowledgement corresponding to the transfer request is received from the determined leaf node. In step S14410, an ordered list is transmitted to the determined leaf node. The ordered list comprises multiple leaf node IDs in a collaborative group, and the order of any two adjacent leaf node IDs satisfy one of the following two rules: (1) the former leaf node ID for a leaf node owning a service state version ID is newer than that owned by a leaf node corresponding to the later leaf node ID and (2) when two adjacent leaf node IDs correspond to leaf nodes owning the same service state version ID, a leaf node corresponding to the former leaf node ID locates on the left or right side of a leaf node corresponding to the later leaf node ID. Referring to FIG. 13, for example, when leaf nodes L₁ to L₄ respectively owns service state values corresponding to service state version IDs V₁₂, V₁₃, V₁₄ and V₁₂, an ordered list is <L₃, L₂, L₁, L₄>. The determined leaf node (i.e. the new master node) transmits the described forward update request to all leaf nodes corresponding to leaf node IDs subsequent to its leaf node ID, such as L₂, L₁ and L₄, in the ordered list. In step S14430, an acknowledgement comprising information indicating that the ordered list has been received from the determined leaf node. In step S14450, a transfer announcement comprising information indicating that the tasks of a master node have been transmitted to the determined leaf node is transmitted to all leaf nodes in the collaborative group. FIG. 15 is a diagram of an exemplary master node transition illustrating that a leaf node L₄ transits the tasks of a master node to a leaf node L₃. Subsequently, the new master node L₃ transmits a forward update request to leaf nodes L₂, L₁ and L₄.

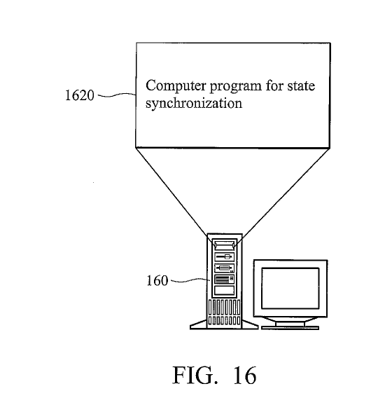

Also disclosed is a storage medium as shown in FIG. 16 storing a computer program 1620 providing the disclosed state synchronization methods. The computer program includes a storage medium 160 having computer readable program code therein for use in a computer system. The computer readable program code, when loaded and executed by the processing unit 21 (FIG. 2), performs the described embodiments of state synchronization methods.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. A method for state synchronization, performed by a first electronic apparatus, comprising:
acquiring a first service state version identification (ID) from a local cache of the first electronic apparatus;
acquiring a plurality of second service state version ID stored in a plurality of local caches of a plurality of second electronic apparatuses by querying the second electronic apparatuses;
determining whether each second service state version ID is older than the first service state version ID; and
transmitting a forward update request to at least one second electronic apparatus owning the older second service state version ID,
enabling the second electronic apparatus owning the older second service state version ID to activate an upward check procedure to update the older second service state version ID,
wherein the first and second service state version IDs are generated by a service resident on a third electronic apparatus, the first, second and third electronic apparatuses are organized in an event casting tree, the third electronic apparatus is a root node of the event casting tree, and the first and second electronic apparatuses are leaf nodes of the event casting tree.

2. The method as claimed in claim 1 further comprising:
receiving a backward update request comprising a third service state version ID newer than the first service state version ID from the second electronic apparatus owning the older second service state version ID after transmitting the forward update request to the second electronic apparatus owning the older second service state version ID;
transmitting a transfer request to the second electronic apparatus generating the backward update request, the transfer request comprising information indicating that the takes for transmitting forward update requests are to be transferred to the second electronic apparatus generating the backward update request; and
transmitting a plurality of transfer announcements to the second electronic apparatuses after receiving an acknowledgement corresponding to the transfer request from the second electronic apparatus generating the backward update request, each transfer announcement comprising information indicating that the takes for transmitting forward update requests have transited to the second electronic apparatus generating the backward update request.

3. The method as claimed in claim 2 further comprising:
transmitting an ordered list to the second electronic apparatus generating the backward update request after receiving an acknowledgement corresponding to the transfer request from the second electronic apparatus generating the backward update request,
wherein the ordered list comprises a plurality of leaf node identifiers (IDs) in sequence respectively corresponding to the first and second electronic apparatuses, any two adjacent leaf node IDs satisfy a first or a second rule, the first rule indicates that the former leaf node ID for a leaf node owning a service state version ID is newer than a service state version ID owned by a leaf node corresponding to the later leaf node ID, and the second rule indicates that, when two adjacent leaf node IDs correspond to leaf nodes owning the same service state version ID, a leaf node corresponding to the former leaf node ID locates on the left or right side of a leaf node corresponding to the later leaf node ID.

4. A method for state synchronization, performed by a first electronic apparatus, comprising:
receiving an upward check request from a second electronic apparatus, the upward check request comprising a first service state version identification (ID) and a first service state value corresponding to the first service state version ID;
acquiring a second service state version ID stored in a local cache of the first electronic apparatus; and
transmitting the upward check request to a third electronic apparatus to activate an upward check procedure when the second service state version ID is older than the first service state version ID, the upward check procedure transmitting the upward check request to an electronic device causing inconsistency between the first and second service state version IDs;
determining whether the third electronic apparatus is unavailable;
replacing the second service state version ID and the second service state value stored in the local cache of the first electronic apparatus with the first service state version ID and the first service state value when the third electronic apparatus is unavailable; and
transmitting a downward update request to the second electronic apparatus to activate a downward update procedure, the downward update procedure downwardly notifying all nodes directly or indirectly connecting to the first electronic apparatus of information instructing the notified nodes to store the first service state value corresponding to the first service state version ID,
wherein the first, second and third electronic apparatuses are organized in an event casting tree, the first electronic apparatus is a parent node of the second electronic apparatus, and the third electronic apparatus is a parent node of the first electronic apparatus.

5. The method as claimed in claim 4 wherein the step for determining whether the third electronic apparatus is unavailable further comprises:
determining that the third electronic apparatus is unavailable when receiving no upward check acknowledgement as the upward check request expires,
wherein the upward check acknowledgement indicates that the third electronic apparatus has received the upward check request.

6. The method as claimed in claim 4 wherein the first and second service state version IDs, and the first and second service state values are generated by a fourth electronic apparatus, and the fourth electronic apparatus locates on the root node of the event casting tree.

7. A method for state synchronization, performed by a first electronic apparatus comprising a local cache storing a first service state version identification (ID) and a first service state value corresponding to the first service state version ID, comprising:
receiving a forward update request comprising a second service state version ID and a second service state value corresponding to the second service state version ID from a second electronic apparatus, the second service state version ID being newer than the first service state version ID;
receiving a downward update request comprising a third service state version ID and a third service state value corresponding to the third service state version ID from a third electronic apparatus after receiving the forward update request;
respectively replacing the first service state version ID and the first service state value in the local cache of the first electronic apparatus with the third service state version ID and the third service state value;
determining whether the third service state version ID is newer than the second service state version ID;
transmitting a backward update request to the second electronic apparatus in order to activate a master node transition procedure when the third service state version ID is newer than the second service state version ID,
wherein the master node transition procedure transfers tasks for transmitting forward update requests from the second electronic apparatus to the first electronic apparatus, the first, second and third electronic apparatuses are organized in an event casting tree, the first and second electronic apparatuses are leaf nodes of the event casting tree, and the third electronic apparatus is a parent node of the first electronic apparatus.

8. The method as claimed in claim 7 wherein the first, second and third service state version IDs, and the first, second and third service state values are generated by a service resident on a fourth electronic apparatus, and the fourth electronic apparatus is the root node of the event casting tree.

9. The method as claimed in claim 7, after receiving the forward update request and before receiving the downward update request, further comprising:
transmitting a upward check request to the third electronic apparatus in order to activate a upward check procedure transmitting the upward check request to an electronic device causing inconsistency between the service state version IDs.

10. A system for state synchronization, comprising:
a first electronic apparatus comprising a service;
a second electronic apparatus;
a third electronic apparatus; and
a fourth electronic apparatus,
wherein the first, second, third and fourth electronic apparatuses are organized in an event casting tree, the first electronic apparatus represents a root node of the event casting tree, the second electronic apparatus represents a relay node of the event casting tree, the third and fourth electronic apparatuses represent leaf nodes of the event casting tree, the third and fourth electronic apparatuses subscribe to a plurality of event notifications from the service, the first electronic apparatus hierarchically transmits the event notifications in sequence to the third and fourth electronic apparatuses via the second electronic apparatus, and the fourth electronic apparatus acquires a first service state version identification (ID) from a local cache of the fourth electronic apparatus, acquires a second service state version ID stored in a local cache of the third electronic apparatuses by querying the third electronic apparatus, determines whether the second service state version ID is older than the first service state version ID, and transmits a forward update request to the third electronic apparatus when the second service state version ID is older than the first service state version ID, enabling the third electronic apparatus to activate an upward check procedure to update the older second service state version ID.

11. The system as claimed in claim 10 wherein the fourth electronic apparatus receives a backward update request comprising a third service state version ID newer than the first service state version ID from the third electronic apparatus after transmitting the forward update request to the third electronic apparatus, transmits a transfer request comprising information indicating that takes for transmitting forward update requests are to be transferred to the third electronic apparatus to the third electronic apparatus, and transmits a transfer announcement comprising information indicating that the takes for transmitting forward update requests have transited to the third electronic apparatus to a fifth electronic apparatus after receiving an acknowledgement corresponding to the transfer request from the third electronic apparatus, the fifth electronic apparatus is a leaf node of the event casting tree, the fifth electronic apparatus subscribe to a plurality of event notifications from the service, and the first electronic apparatus hierarchically transmits the event notifications in sequence to the fifth electronic apparatus via the second electronic apparatus.

12. The system as claimed in claim 11 wherein the fourth electronic apparatus transmits an ordered list to the third electronic apparatus after receiving an acknowledgement corresponding to the transfer request from the third electronic apparatus, the ordered list comprises a plurality of leaf node identifiers (IDs) in sequence respectively corresponding to the first and second electronic apparatuses, any two adjacent leaf nod IDs satisfy a first or a second rule, the first rule indicates that the former leaf node ID for a leaf node owning a service state version ID is newer than a service state version ID owned by a leaf node corresponding to the later leaf node ID, and the second rule indicates that, when two adjacent leaf node IDs correspond to leaf nodes owning the same service state version ID, a leaf node corresponding to the former leaf node ID locates on the left or right side of a leaf node corresponding to the later leaf node ID.

13. The system as claimed in claim 10 wherein the second electronic apparatus receives an upward check request comprising the first service state version ID and the first service state value corresponding to the first service state version ID from the third electronic apparatus, acquires a third service state version ID stored in a local cache of the second electronic apparatus, and transmits the upward check request to a fifth electronic apparatus to activate an upward check procedure when the third service state version ID is older than the first service state version ID, the upward check procedure transmits the upward check request to an electronic device causing inconsistency between the service state version IDs, the fifth electronic apparatus is a relay node of the event casting tree and a parent node of the second electronic apparatus, the second electronic apparatus determines whether the fifth electronic apparatus is unavailable, updates the third service state version ID and the third service state value stored in the local cache of the second electronic apparatus with the first service state version ID and the first service state value when the fifth electronic apparatus is unavailable, and transmits a downward update request to the third electronic apparatus to activate a downward update procedure, the downward update procedure downwardly notifies the third electronic apparatus of information instructing the third electronic apparatus to store the first service state value corresponding to the first service state version ID.

14. The system as claimed in claim 13 wherein the second electronic apparatus determines that the fifth electronic apparatus is unavailable when receiving no upward check acknowledgement as the upward check request expires, and the upward check acknowledgement indicates that the fifth electronic apparatus has received the upward check request.

15. The system as claimed in claim 10 wherein the third electronic apparatus receives the forward update request comprising the first service state version ID and a first service state value corresponding to the first service state version ID from the fourth electronic apparatus, the first service state version ID is newer than the second service state version ID, the third electronic apparatus receives a downward update request comprising a third service state version ID and a third service state value corresponding to the third service state version ID from the second electronic apparatus after receiving the forward update request, respectively replaces the second service state version ID and the second service state value in the local cache of the third electronic apparatus with the third service state version ID and the third service state value, determines whether the third service state version ID is newer than the first service state version ID, and transmits a backward update request to the fourth electronic apparatus in order to activate a master node transition procedure when the third service state version ID is newer than the first service state version ID, and the master node transition procedure transfers tasks for transmitting forward update requests from the fourth electronic apparatus to the third electronic apparatus.

16. The system as claimed in claim 15 wherein the third electronic apparatus transmits a upward check request to the second electronic apparatus in order to activate a upward check procedure transmitting the upward check request to an electronic device causing inconsistency between the service state version IDs after receiving the forward update request and before receiving the downward update request.
